(19) United States
(12) Patent Application Publication
(10) Pub. No.: US 2023/0150399 A1
(43) Pub. Date: May 18, 2023

(54) METHOD FOR CONTROLLING FUEL CELL OF VEHICLE, APPARATUS, AND MEDIUM

(71) Applicant: Great Wall Motor Company Limited, Baoding, Hebei (CN)

(72) Inventors: Mingwang ZHOU, Baoding, Hebei (CN); Baogang WANG, Baoding, Hebei (CN); Han LIU, Baoding, Hebei (CN); Tong KANG, Baoding, Hebei (CN); Yipo HU, Baoding, Hebei (CN); Zheng ZHANG, Baoding, Hebei (CN); Ming GAO, Baoding, Hebei (CN)

(21) Appl. No.: 18/001,520

(22) PCT Filed: Jun. 10, 2021
(86) PCT No.: PCT/CN2021/099465

§ 371 Date: Dec. 12, 2022

(30) Foreign Application Priority Data
Jun. 15, 2020 (CN) 202010542522.X

(51) Int. Cl. B60L 58/40; B60L 58/12; B60L 58/31; G01C 21/36

(52) U.S. Cl. CPC B60L 58/40; B60L 58/12; B60L 58/31; G01C 21/3691

(57) ABSTRACT

A method for controlling a fuel cell of a vehicle, is provided. The vehicle includes a fuel cell and a power battery. The method includes the following steps: detecting road condition information for a planned driving route of the vehicle; detecting a battery level of the power battery; and controlling an activation or a deactivation of the fuel cell according to the road condition information and/or the battery level of the power battery.

### CROSS-REFERENCE TO RELATED APPLICATIONS

This application is a 35 U.S.C.§371 national stage application of PCT Application Ser. No. PCT/CN2021/099465 filed on Jun. 10, 2021, which claims the benefit of Chinese Patent Application No. 202010542522.X filed on Jun. 15, 2020, the entire content of which is incorporated herein by reference.

### FIELD

The present disclosure relates to the field of vehicle control technology, and in particular, to a method for controlling a fuel cell of a vehicle, an apparatus and a medium.

### BACKGROUND

Fuel cell (e.g., hydrogen fuel cell) vehicles, when in use, will involve the activation and deactivation of fuel cell. At present, the timing to activate or deactivate of the fuel cell is determined mainly based on a current driving mode, a power requested by a power system, a power that a power battery can output and other thresholds. If the driver’s driving habits are poor, frequent activation or deactivation of the fuel cell will be resulted, not only too much power of the power battery can be consumed, but also the service life of the fuel cell can also be shortened.

### SUMMARY

In view of this, a first aspect of the present disclosure provides a method for controlling a fuel cell of a vehicle, to save electrical energy of the power battery and extend the service life of the fuel cell.

To achieve the foregoing objectives, embodiments of the present disclosure are implemented as follows:

A method for controlling a fuel cell of a vehicle is provided, the vehicle includes a fuel cell and a power battery. The method includes steps of: detecting road condition information for a planned driving route of the vehicle; detecting a battery level of the power battery; and controlling an activation or a deactivation of the fuel cell based on the road condition information and/or the battery level of the power battery.

In an embodiment, the step of controlling an activation or a deactivation of the fuel cell based on the road condition information and/or the battery level of the power battery includes a step of controlling the fuel cell to be deactivated when the battery level of the power battery is greater than or equal to a first threshold.

In an embodiment, the step of controlling an activation or a deactivation of the fuel cell based on the road condition information and/or the battery level of the power battery includes a step of controlling the fuel cell to be deactivated when the battery level of the power battery is smaller than the first threshold and greater than or equal to a second threshold, and the road condition information meets a special road condition.

In an embodiment, the step of controlling an activation or a deactivation of the fuel cell based on the road condition information and/or the battery level of the power battery includes a step of controlling the fuel cell to be activated when the battery level of the power battery is smaller than or equal to a third threshold, where the third threshold is smaller than the second threshold.

In an embodiment, the special road condition includes at least one of the following that: a ramp is smaller than a gradient threshold and a length is greater than a first length threshold, time duration of a red light is greater than a time threshold, a velocity of the vehicle is smaller than a velocity threshold, and a distance of the vehicle to a destination is smaller than a second length threshold.

The method for controlling a fuel cell of a vehicle described in the present disclosure has the following advantages with respect to the existing technologies: The vehicle includes the fuel cell and the power battery, firstly, the road condition information for the planned driving route of the vehicle is detected, then, the battery level of the power battery is detected, and finally, the activation or deactivation of the fuel cell is controlled according to the road condition information and/or the battery level of the power battery. It is determined based on the road conditions whether the vehicle needs to stop for a long time or needs to be driven slowly, and the fuel cell is controlled to be activated or deactivated to reduce the times of activation or deactivation of the fuel cell, thus the power consumption of the power battery caused by frequent activation of the fuel cell is reduced, thereby achieving the objectives of saving energy and extending the service life of the fuel cell.

A second aspect of the present disclosure provides a device for controlling a fuel cell of a vehicle to save electrical energy of the power battery and extend the service life of the fuel cell.

To achieve the above objectives, embodiments of the present disclosure are implemented as follows.

A device for controlling a fuel cell of a vehicle is provided, the vehicle includes a fuel cell and a power battery, the device includes a detection unit and a control unit. The detection unit is configured to detect road condition information for a planned driving route of the vehicle, and detect a battery level of the power battery. The control unit is configured to control an activation or a deactivation of the fuel cell according to the road condition information and/or the battery level of the power battery.

In an embodiment, the control unit is also configured to control the fuel cell to be deactivated when the battery level of the power battery is greater than or equal to a first threshold.

In an embodiment, the control unit is also configured to control the fuel cell to be deactivated when the battery level of the power battery is smaller than the first threshold and greater than or equal to a second threshold, and the road condition information meets a special road condition.

In an embodiment, the control unit is also configured to control the fuel cell to be activated when the battery level of the power battery is smaller than or equal to a third threshold, where the third threshold is smaller than the second threshold.

In an embodiment, the special road condition includes at least one of the following that: a ramp is smaller than a gradient threshold and a length is greater than a first length threshold, time duration of a red light is greater than a time threshold, a velocity of the vehicle is smaller than a velocity threshold, and a distance of the vehicle to a destination is smaller than a second length threshold.

The device for controlling the fuel cell has the same advantages as the method for controlling the fuel cell with respect to the existing technologies, which will not be repeated herein.

To achieve the objectives, a third aspect of the present disclosure provides a computing processing device, which includes: a memory in which a computer readable code is stored; and one or more processors. The computing processing apparatus is configured to perform the method for controlling a fuel cell of a vehicle as set forth in the first aspect of the embodiments of the present disclosure when the computer readable code is executed by the one or more processors.

To achieve the objectives, a fourth aspect of the present disclosure provides a computer program including a computer readable code. The computer readable code, when run on a computing processing apparatus, causes the computing processing apparatus to perform the method for controlling a fuel cell of a vehicle as set forth in the first aspect of the embodiments of the present disclosure.

To achieve the objectives, a fifth aspect of the present disclosure provides a computer readable storage medium in which the computer program as set forth in the fourth aspect of the embodiment of the present disclosure is stored.

Other features and advantages of the present disclosure will be further described in the detailed description of the embodiments.

### BRIEF DESCRIPTION OF THE DRAWINGS

The drawings that form part of this disclosure are used to provide a further understanding of the present disclosure, exemplary embodiments of the present disclosure and description of the exemplary embodiments are used to explain the present disclosure and do not constitute unnecessary limitations of the present disclosure. In the drawings:

FIG. 1 is a flowchart of a method for controlling a fuel cell of a vehicle in accordance with an embodiment of the present disclosure;

FIG. 2 is a flowchart of a method for controlling a fuel cell for a vehicle in accordance with another embodiment of the present disclosure;

FIG. 3 is a block diagram of a structure of a device for controlling a fuel cell of a vehicle in accordance with an embodiment of the present disclosure;

FIG. 4 is a schematic diagram of a structure of a computing processing apparatus in accordance with an embodiment of the present disclosure; and

FIG. 5 is a schematic diagram of a storage unit for portable or stationary implementation of a program code for the method according to the present disclosure, in accordance with an embodiment of the present disclosure.

### DETAILED DESCRIPTION OF THE EMBODIMENTS

It should be understood that the embodiments and features in the embodiments of the present disclosure may be combined with each other in the absence of conflict.

The present disclosure will be described in detail below with reference to the drawings and in conjunction with the embodiments.

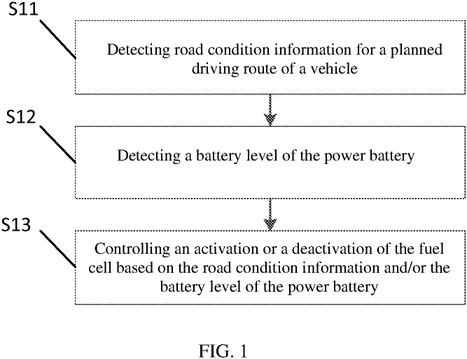

FIG. 1 is a flowchart of a method for controlling a fuel cell of a vehicle provided in an embodiment of the present disclosure. As shown in FIG. 1, the vehicle includes a fuel cell and a power battery, and the method includes steps S11 to S13.

In step S11, it is detected road condition information for a planned driving route of a vehicle.

Specifically, for example, the road condition information of the planned driving route of the vehicle is detected in combination with the intelligent navigation system. More specifically, a head unit system (HUT) will remind the driver to input a destination of this trip through a pop-up frame, and then the HUT will plan several different driving routes for the driver to choose through the intelligent navigation system. After the driving route is determined by the driver, the intelligent navigation system will be utilized by the vehicle to monitor current road condition information on the planned driving route in real time, and then the current road condition information is sent to a power control unit (PCU).

In step S12, it is detected a battery level of the power battery.

Specifically, an actual battery level of the power battery, such as a lithium battery, may be synchronously sent to the PCU by a battery management system (BMS).

In step S13, an activation or a deactivation of the fuel cell is controlled according to the road condition information and/or the battery level of the power battery.

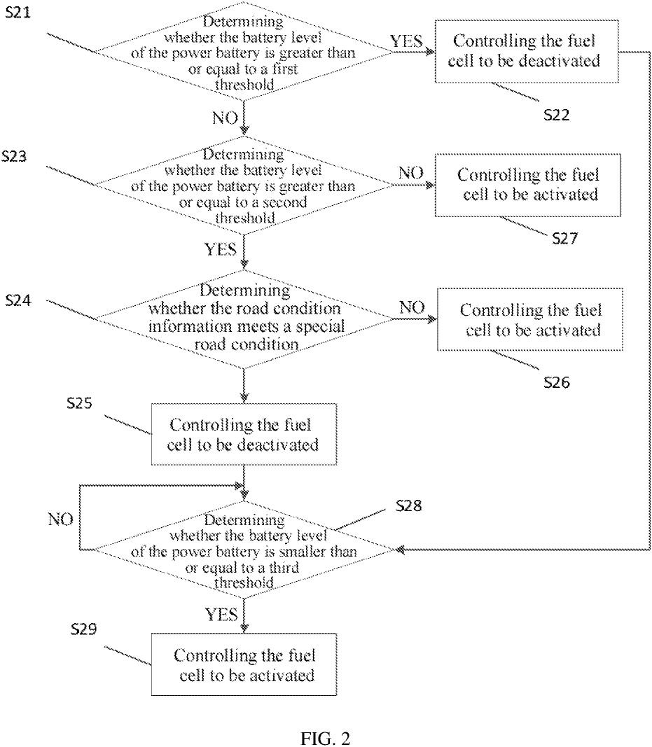

Specifically, the method for controlling the activation or deactivation of the fuel cell is shown in FIG. 2, the method includes steps S21 to S29.

In step S21, it is determined whether the battery level of the power battery is greater than or equal to a first threshold.

Specifically, the vehicle may first be controlled to run on fuel cell. Then adjustments may be made based on the battery level of the power battery. For example, it is firstly determined whether the battery level of the power battery is greater than or equal to the first threshold, and the first threshold may be 80%, which will not be limited in here.

In step S22, the fuel cell is controlled to be deactivated when the battery level of the power battery is greater than or equal to the first threshold.

Specifically, if the power battery is greater than or equal to the first threshold, then the fuel cell is controlled to be deactivated regardless of the road condition information, i.e., the vehicle is enabled to run on pure power using the power battery in this case, and thereafter, in case that the battery level of the power battery is greater than a third threshold (for example, but not limited to, 30%), the fuel cell will not be activated regardless of how the battery level of the power battery changes or how the road condition information changes, to avoid frequent activation or deactivation of the fuel cell.

In step S23, it is determined whether the battery level of the power battery is greater than or equal to a second threshold when the battery level of the power battery is smaller than the first threshold.

Specifically, if the battery level of the power battery is smaller than the first threshold, then it is necessary to determine whether the battery level of the power battery is greater than or equal to a second threshold, and the second threshold may be 60% when the first threshold is 80%, which also will not be limited in here.

In step S24, it is determined whether the road condition information meets a special road condition when the battery level of the power battery is greater than or equal to the second threshold.

Specifically, the special road condition includes at least one of the following that: a ramp is smaller than a gradient threshold (for example, but not limited to, -10 °) and a length is greater than a first length threshold (for example, but not limited to, 1 km), time duration of a red light is greater than a time threshold (for example, but not limited to, 30 s), a velocity of the vehicle is smaller than a velocity threshold (for example, but not limited to, 10 km/h) and a distance of the vehicle to the destination is smaller than a second length threshold (for example, but not limited to, 5 km). If the battery level of the power battery is greater than or equal to the second threshold, then it is necessary to also determine whether the road condition information meets the above special road condition.

In step S25, the fuel cell is controlled to be deactivated when the road condition information meets the special road condition.

Specifically, if the road condition information meets the special road condition, then the fuel cell is controlled to be deactivated, i.e., the vehicle is enabled to be driven on pure power using the power battery in this case, and thereafter, in case that the battery level of the power battery is greater than the third threshold, the fuel cell will not be activated regardless of how the battery level of the power battery changes or how the road condition information changes, to avoid frequent activation or deactivation of the fuel cell.

In step S26, the fuel cell is controlled to be activated when the road condition information does not meet the special road condition.

Specifically, the fuel cell is controlled to remain activated when the road condition information does not meet the special road condition, meanwhile the power battery is charged, so that the fuel cell can be deactivated after the battery level of the power battery is gradually increased to be greater than or equal to the first threshold.

In step S27, the fuel cell is controlled to be activated when the battery level of the power battery is smaller than the second threshold.

Specifically, if the battery level of the power battery is smaller than the second threshold, then the fuel cell is controlled to remain activated regardless of the road condition information, and meanwhile the power battery is charged so that the fuel cell can be deactivated after the battery level of the power battery is gradually increased to be greater than or equal to the first threshold.

In step S28, it is determined whether the battery level of the power battery is smaller than or equal to a third threshold.

Specifically, with the use of the power battery of the vehicle, the battery level of the power battery keeps dropping, so it is necessary to determine whether the battery level of the power battery is smaller than or equal to the third threshold.

In step S29, the fuel cell is controlled to be activated when the battery level of the power battery is smaller than or equal to the third threshold.

Specifically, if the battery level of the power battery is smaller than or equal to the third threshold, then the vehicle can no longer be driven on pure electricity, so the fuel cell is controlled to be activated, meanwhile the power battery is charged so that the fuel cell can be deactivated after the battery level of the power battery is increased gradually to be greater than or equal to the first threshold.

In the embodiments of the present disclosure, the timing for activating the fuel cell is determined according to the battery level of the power battery ( the fuel cell is allowed to be deactivated when the battery level is high enough), and the intelligent navigation system is participated for predicting the subsequent road conditions to determine whether the vehicle needs to stop for a long time or needs to be driven slowly, the activation or deactivation of the fuel cell is controlled by the PCU to reduce times of activation or deactivation of the fuel cell, thereby reducing power consumption of the power battery caused by frequent activation of the fuel cell is and ultimately achieving the objectives of saving energy and extending the service life of the fuel cell.

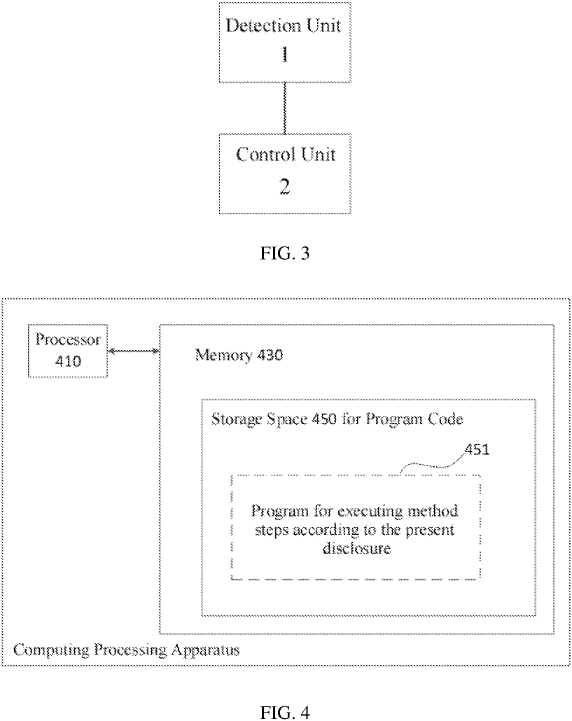

FIG. 3 is a block diagram of a structure of a device for controlling a fuel cell of a vehicle provided in an embodiment of the present disclosure. As shown in FIG. 3, the vehicle includes a fuel cell and a power battery, and the device includes a detection unit 1 and a control unit 2. The detection unit 1 is configured to: detect road condition information of a planned driving route of the vehicle; and detect a battery level of the power battery. The control unit 2 is configured to control an activation or deactivation of the fuel cell according to the road condition information and/or the battery level of the power battery.

In an embodiment, the control unit 2 is also configured to control the fuel cell to be deactivated when the battery level of the power battery is greater than or equal to a first threshold.

In an embodiment, the control unit 2 is also configured to control the fuel cell to be deactivated when the battery level of the power battery is smaller than the first threshold and greater than or equal to a second threshold and the road condition information meets the special road condition.

In an embodiment, the control unit 2 is also configured to control the fuel cell to be activated when the battery level of the power battery is smaller than or equal to a third threshold, where the third threshold is smaller than or equal to the second threshold.

In an embodiment, the special road condition includes at least one of the following that: a ramp is smaller than a gradient threshold and a length is greater than a first length threshold, time duration of a red light is greater than a time threshold, a velocity of the vehicle is smaller than a velocity threshold, and a distance of the vehicle to a destination is smaller than a second length threshold.

The device for controlling the fuel cell of the vehicle described in the above embodiment are similar to the method embodiments for controlling the fuel cell of the vehicle as above-described, which will not be repeated herein.

The above are merely some preferred embodiments of the present disclosure, which are not intended to limit the present disclosure. Any modifications, equivalent substitutions, improvements, etc. made within the spirit and principles of the present disclosure shall be included in the protection scope of the present disclosure.

To achieve the above embodiments, the present disclosure also provides a computing processing apparatus, which includes: a memory in which a computer readable code is stored; and one or more processors. The computer readable code, when executed by the one or more processors, causes the computing processing apparatus to perform the aforementioned method for controlling the fuel cell of the vehicle.

To implement the foregoing embodiments, the present disclosure also provides a computer program, which includes the computer readable code that, when run on the computing processing apparatus, causes the computing processing apparatus to perform the aforementioned method for controlling a fuel cell of a vehicle.

To implement the foregoing embodiments, the present disclosure also provides a computer readable storage medium, in which the foregoing computer program is stored.

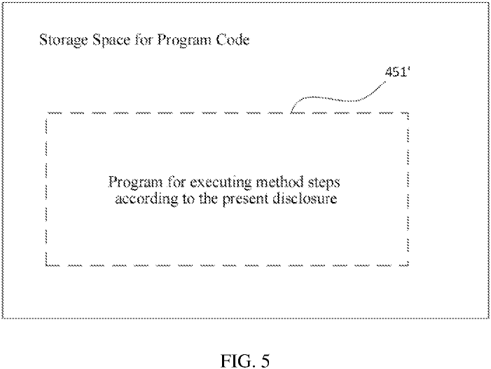

FIG. 4 is a schematic structural diagram of a computing processing apparatus provided in an embodiment of the present disclosure. The computing processing apparatus typically includes a processor 410 and a computer program product or computer-readable medium in the form of memory 430. The memory 430 may be an electronic memory such as a flash memory, an electrically erasable programmable read-only memory (EEPROM), an EPROM, a hard disk, or a ROM. The memory 430 has a storage space 450 for program code 451 for executing any of the method steps in the above-described methods. For example, the storage space 450 for program code may include individual program codes 451 for implementing the various steps in the method described above, respectively. These program codes may be read from or written to one or more computer program products. These computer program products include program code carriers such as hard disks, compact disks (CDs), memory cards, or floppy disks. Such a computer program product is typically a portable or fixed storage unit as shown in FIG. 5. The storage unit may have arrangements of storage segments, storage space, etc., similar to that of the memory 430 in a server of FIG. 4. The program code may, for example, be compressed in an appropriate form. Typically, the memory unit includes computer readable code 451′, i.e., code that can be read by, for example, a processor such as 410 which, when run by a server, causes that server to perform the various steps in the method described above.

In the description of this specification, references to terms of “an embodiment”, “some embodiments”, “example”, “specific example”, or “some examples” mean that the specific features, structures, materials, or characteristics described in conjunction with the embodiment or example are included in at least one embodiment or example of the present disclosure. In this specification, the schematic representations of the above terms do not have to be directed to the same embodiment or example. Moreover, the specific features, structures, materials, or characteristics described may be combined in a suitable manner in any one or more embodiments or examples. In addition, in absence of conflicts, a person skilled in the art may combine the different embodiments or examples described in this specification and the features of the different embodiments or examples.

In addition, the terms “first” and “second” are used for descriptive purposes only and are not to be construed as indicating or implying relative importance or implicitly indicating the number of features indicated. Thus, a feature qualified with “first” and “second” may explicitly or implicitly include at least one such feature. In the description of the present disclosure, the phrase “a plurality of” means at least two, e.g., two, three, etc., unless otherwise expressly and specifically limited.

Any process or method description described in a flowchart or otherwise described herein may be understood to represent a module, a fragment, or a portion of code including one or more executable instructions for implementing steps of a customized logical function or process. In addition, the scope of preferred embodiments of the present disclosure includes additional implementations, which may not be performed in the order shown or discussed, including in substantially simultaneous order depending on the function involved, or in the reverse order. or in the reverse order, as should be understood by those skilled in the field to which embodiments of the present disclosure belong.

The logic and/or steps represented in the flowchart or otherwise described herein, for example, may be considered a definitive list of executable instructions for implementing the logical functions, and may be specifically implemented in any computer-readable medium for use by an instruction execution system, device, or apparatus (e.g., a computer-based system, a system including a processor, or other system that can take instructions from an instruction execution system, device, or apparatus and execute the instructions) or to be used in conjunction with these instruction execution systems, devices, or apparatus. For purposes of this specification, a “computer readable medium” may be any device that can contain, store, communicate, transmit, or transfer a program for use by or in conjunction with an instruction execution system, device, or apparatus. More specifically, examples of computer-readable media (a non-exhaustive list) include the following: electrically-connected sections (electronic devices) having one or more wiring, portable computer disk cartridges (magnetic devices), a random-access memory (RAM), a read-only memory (ROM), an erasable editable read-only memory (EPROM or a flash memory), fiber optic devices, and a portable compact disc read-only memory (CDROM). Alternatively, the computer readable medium may even be paper or other suitable medium on which the program may be printed, since the program may be obtained electronically, for example, by optical scanning of the paper or other medium, followed by editing, deciphering or, if necessary, processing in other suitable ways, and then storing it in the memory of a computer.

It should be understood that the various parts of the present disclosure may be implemented with hardware, software, firmware, or a combination thereof. In the above embodiments, a plurality of steps or methods may be implemented with software or firmware stored in memory and executed by a suitable instruction execution system. For example, if implemented in hardware, as in another implementation, any of the following well-known techniques: discrete logic circuits having logic gates for implementing logic functions on data signals, specialized integrated circuits having suitable combinations of logic gates, programmable gate arrays (PGAs), field programmable gate arrays (FPGAs), etc., or a combination thereof.

A person of ordinary skill in the art can understand that all or some of the steps carried by the method of the above embodiments can be implemented by instructing the relevant hardware by means of a program, the program may be stored in a computer readable storage medium which, when executed, caused one of the steps of the method embodiments or a combination thereof to be performed.

In addition, each functional unit in the various embodiments of the present disclosure may be integrated in a processing module, or the individual units may physically exist separately, or two or more units may be integrated in a single module. The integrated module may be implemented either in the form of hardware or in the form of software functional modules. The integrated module may also be stored in a computer readable storage medium if it is implemented in the form of software function modules and sold or used as a standalone product.

The above-mentioned storage medium may be a read-only memory, a disk or a CD-ROM, etc. Although embodiments of the present disclosure have been shown and described above, it should be understood that the above embodiments are exemplary embodiments and should not be construed as limitations to the present disclosure, and that variations, modifications, replacements and variants of the above embodiments may be made by ordinary technicians in the field within the scope of the present disclosure.

1. A method for controlling a fuel cell of a vehicle, the vehicle comprising a fuel cell and a power battery, the method comprising:
detecting road condition information for a planned driving route of a vehicle;
detecting a battery level of the power battery; and
controlling an activation or a deactivation of the fuel cell based on the road condition information and/or the battery level of the power battery.

2. The method for controlling a fuel cell of a vehicle according to claim 1, wherein the controlling an activation or a deactivation of the fuel cell based on the road condition information and/or the battery level of the power battery comprises:
controlling the fuel cell to be deactivated when the battery level of the power battery is greater than or equal to a first threshold.

3. The method for controlling a fuel cell of a vehicle according to claim 1, wherein the controlling an activation or a deactivation of the fuel cell based on the road condition information and/or the battery level of the power battery comprises:
controlling the fuel cell to be deactivated when the battery level of the power battery is smaller than the first threshold and greater than or equal to a second threshold, and the road condition information meets a special road condition.

4. The method for controlling a fuel cell of a vehicle according to claim 1, wherein the controlling an activation or a deactivation of the fuel cell based on the road condition information and/or the battery level of the power battery comprises:
controlling the fuel cell to be activated when the battery level of the power battery is smaller than or equal to a third threshold, wherein the third threshold is smaller than the second threshold.

5. The method for controlling a fuel cell of a vehicle according to claim 3, wherein the special road condition comprises at least one of:
a ramp is smaller than a gradient threshold and a length is greater than a first length threshold, time duration of a red light is greater than a time threshold, a velocity of the vehicle is smaller than a velocity threshold, and a distance of the vehicle to a destination is smaller than a second length threshold.

6-11. (canceled)

12. A computing processing apparatus, comprising:
a memory in which a computer readable code is stored; and
at least one processors, wherein the computer readable code, when executed by the at least one processors, causes the computing processing apparatus to perform operations that comprise:
detecting road condition information for a planned driving route of a vehicle;
detecting a battery level of the power battery; and
controlling an activation or a deactivation of the fuel cell based on the road condition information and/or the battery level of the power battery.

13. (canceled)

14. A non-transitory computer readable storage medium, which stores a computer program, that, when executed by a processor of a computing processing apparatus, causes the processor of the computing processing apparatus to perform operations that comprise:
detecting road condition information for a planned driving route of a vehicle;
detecting a battery level of the power battery; and
controlling an activation or a deactivation of the fuel cell based on the road condition information and/or the battery level of the power battery.

15. The method for controlling a fuel cell of a vehicle according to claim 2, wherein the controlling an activation or a deactivation of the fuel cell based on the road condition information and/or the battery level of the power battery comprises:
controlling the fuel cell to be activated when the battery level of the power battery is smaller than or equal to a third threshold, wherein the third threshold is smaller than the second threshold.

16. The method for controlling a fuel cell of a vehicle according to claim 3, wherein the controlling an activation or a deactivation of the fuel cell based on the road condition information and/or the battery level of the power battery comprises:
controlling the fuel cell to be activated when the battery level of the power battery is smaller than or equal to a third threshold, wherein the third threshold is smaller than the second threshold.

17. The computing processing apparatus according to claim 12, wherein the operation of controlling an activation or a deactivation of the fuel cell based on the road condition information and/or the battery level of the power battery comprises:
controlling the fuel cell to be deactivated when the battery level of the power battery is greater than or equal to a first threshold.

18. The computing processing apparatus according to claim 12, wherein the operation of controlling an activation or a deactivation of the fuel cell based on the road condition information and/or the battery level of the power battery comprises:
controlling the fuel cell to be deactivated when the battery level of the power battery is smaller than the first threshold and greater than or equal to a second threshold, and the road condition information meets a special road condition.

19. The computing processing apparatus according to claim 12, wherein the operation of controlling an activation or a deactivation of the fuel cell based on the road condition information and/or the battery level of the power battery comprises:
controlling the fuel cell to be activated when the battery level of the power battery is smaller than or equal to a third threshold, wherein the third threshold is smaller than the second threshold.

20. The computing processing apparatus according to claim 18, wherein the special road condition comprises at least one of:
a ramp is smaller than a gradient threshold and a length is greater than a first length threshold, time duration of a red light is greater than a time threshold, a velocity of the vehicle is smaller than a velocity threshold, and a distance of the vehicle to a destination is smaller than a second length threshold.

21. The non-transitory computer readable storage medium according to claim 14, wherein the operation of controlling an activation or a deactivation of the fuel cell based on the road condition information and/or the battery level of the power battery comprises:
controlling the fuel cell to be deactivated when the battery level of the power battery is greater than or equal to a first threshold.

22. The non-transitory computer readable storage medium according to claim 14, wherein the operation of controlling an activation or a deactivation of the fuel cell based on the road condition information and/or the battery level of the power battery comprises:
controlling the fuel cell to be deactivated when the battery level of the power battery is smaller than the first threshold and greater than or equal to a second threshold, and the road condition information meets a special road condition.

23. The non-transitory computer readable storage medium according to claim 14, wherein the operation of controlling an activation or a deactivation of the fuel cell based on the road condition information and/or the battery level of the power battery comprises:
controlling the fuel cell to be activated when the battery level of the power battery is smaller than or equal to a third threshold, wherein the third threshold is smaller than the second threshold.

24. The non-transitory computer readable storage medium according to claim 22, wherein the special road condition comprises at least one of:
a ramp is smaller than a gradient threshold and a length is greater than a first length threshold, time duration of a red light is greater than a time threshold, a velocity of the vehicle is smaller than a velocity threshold, and a distance of the vehicle to a destination is smaller than a second length threshold.
